(19) United States
(12) Patent Application Publication
(10) Pub. No.: US 2002/0057992 A1
(43) Pub. Date: May 16, 2002

(54) Method for treating objects

(75) Inventors: Ralf Eckert, Dossenheim (DE); Robert Gropp, Schifferstadt (DE)

Correspondence Address: Simpson, Simpson & Snyder, PLLC, 555 Main Street, Williamsville, NY, 14221, US

(73) Assignee: Leica Microsystems Nussloch GmbH, Nussloch (DE)

(21) Appl. No.: 09/933,414

(22) Filed: Aug. 20, 2001

(30) Foreign Application Priority Data
Aug. 22, 2000 (DE) 100 41 226.2

(51) Int. Cl. G01N 35/00

(52) U.S. Cl. 422/63; 436/43; 422/100

(57) ABSTRACT

A method for treating objects, in particular cytological or histological specimens, for example in an automatic stainer or in a tissue processor, the objects, preferably on object carriers and optionally in object carrier magazines, being delivered by means of a transport device to various processing stations, inserted there, and treated in accordance with a definable treatment program, is characterized by a throughput optimization on the basis of minimal movement distances of the transport device.

### CROSS REFERENCE TO RELATED APPLICATIONS

This invention claims priority of the German patent application 100 41 226.2 filed Aug. 22, 2000 which is incorporated by reference herein.

### FIELD OF THE INVENTION

The present invention concerns a method for treating objects, in particular cytological or histological specimens, for example in an automatic stainer or in a tissue processor, the objects, preferably on object carriers and optionally in object carrier magazines, being delivered by means of a transport device to various processing stations, inserted there, and treated in accordance with a definable treatment or processing program. Let it be noted at this juncture that the method can be utilized only by way of example in an automatic stainer, but that the method is not limited to that utilization. Let it also be noted that in the context of the utilization of the method under discussion here in a tissue processor, the samples or objects are not necessarily arranged on object carriers.

### BACKGROUND OF THE INVENTION

The reader is referred, merely by way of example, to EP 0 849 582 A2. This document discloses a generic method for treating objects, in particular cytological or histological specimens. In this, cytological or histological specimens are conveyed by means of an object carrier or basket, and optionally in magazines, to the variously operating treatment stations of an automatic stainer, the automatic stainer comprising multiple treatment stations with different reagents.

The generic method known from EP 0 849 582 A2. refers to an automatic stainer (multistainer), concretely to an apparatus for staining histological specimens. These specimens are made available on an object carrier, and multiple object carriers can be arranged in magazines. The various treatment stations or processing stations are reached by way of a transport apparatus that can comprise a robot arm. The transport apparatus transports the object carriers or object carrier magazines to the respective treatment stations, at or in which treatment actions are performed in accordance with a selectable staining method. The object carriers or object carrier magazines are inserted into the reagent-containing vessels of the treatment stations so that after release of the respective object carrier or object carrier magazine, the transport apparatus can continue transporting irrespective of the treatment that is taking place.

In the case of the known automatic stainers and the method utilized therein for treating cytological or histological specimens, the processing stations are arranged in more or less rigid fashion irrespective of the staining program to be executed, so that the transport device must be moved in accordance with the positioning of the respective processing stations. This results in a very considerable expenditure of time for moving the object carriers, the period between the treatment times always being available for the movement of object carriers.

### SUMMARY OF THE INVENTION

It is the object of the present invention to configure and further develop a generic method for treating objects, in particular cytological or histological specimens, in such a way that as many transport actions as possible can be performed within the processing times in the processing stations.

### DETAILED DESCRIPTION OF THE INVENTION

The aforesaid object is achieved by improving a generic method for treating objects, in particular cytological and histological specimens, such that the method is characterized by a throughput optimization on the basis of minimal movement distances of the transport device.

What has been recognized according to the present invention is firstly that in order to create the basis for a throughput optimization, as many transport actions as possible must be performed within the treatment times, i.e. in the course of the treatments taking place in the treatment stations. If the transport device travels minimal movement distances, a maximum number of transport actions can be performed and the overall throughput is thereby increased, at least if a sufficient number of processing stations are present, i.e. also for concurrent treatment using identical treatment methods or contents in the treatment stations or processing stations.

Shortest movement distances for the transport devices can be achieved by means of mathematical models, in particular by means of graph theory approaches and/or network planning technique approaches. In this context, an optimization could take place for a given arrangement of the processing stations (and with no modification thereof), matched in each case to the respective staining program. If different staining programs are being executed simultaneously, an optimization takes place in consideration of all the movement distances.

In very particularly advantageous fashion, the movement distances of the transport device are minimized by arranging or rearranging the processing stations that are to be traveled to in a defined sequence in order to execute the respective processing programs. A new arrangement or rearrangement of the processing stations can be accomplished by the fact that the vessels present in the stations are displaced, preferably with the aid of the transport device. It is also conceivable, however, to fill the processing stations in accordance with treatment programs that are to be executed, the optimum content or optimum arrangement of the processing stations being defined by a computer, specifically in consideration of the treatment or processing program to be executed.

As already indicated previously, the transport device is to be handled independently of the object carriers or object carrier magazines, so that after an object carrier or object carrier magazine has been inserted into the treatment station, the transport device can continue to operate during the treatment. It is consequently possible, during the treatment time of an object carrier magazine, to grasp and move other object carrier magazines and deliver them into other processing stations. Concurrent processing or treatment in various processing stations in accordance with multiple processing programs is possible, specifically —according to the teaching claimed —in throughput-optimized fashion.

Once again, let it be emphasized very particularly that transport actions take place within the treatment times in the processing stations. The shorter the movement distances required —specifically on the basis of either optimized movement distances and/or a very particular arrangement or rearrangement of the processing stations —the more transport actions can take place within the processing times. In this respect, the arrangement of the processing stations or reagent stations required for the processing steps, and thus the content of the respective stations, has a decisive influence on the throughput of the unit.

The throughput optimization aimed at here is calculated using an electronic data processing program, and can be executed on a computer integrated into the treatment unit. Essentially any computer is suitable for use here, including, for example, a PC (personal computer). Similar electronic data processing systems (logically operating assemblies), for example a microcontroller, are usable. After calculation of an optimum arrangement of the processing stations and/or shortest movement distances, the transport device is controlled directly. A corresponding adaptation of the entire processing operation takes place.

It is also conceivable for the electronic data processing program calculating the optimization to be executed by an external computer, preferably by a PC. In this respect, retrofitting with a corresponding optimization program is readily possible, and the external PC can then also provide process control. In the context of a very particularly simple embodiment, the external PC could merely calculate an optimized arrangement of the processing stations, so that the user can manually effect the optimized arrangement of the processing stations or the corresponding filling of the vessels therein with reagents. Ultimately, an optimized arrangement of the processing stations could simply be defined for the user, so that further retooling measures in the unit itself, especially any intervention necessary for control purposes, are unnecessary.

In conclusion, let it be emphasized once again very particularly that the optimization under discussion here can be utilized in an automatic stainer for treating cytological or histological specimens. The processing stations are embodied in this context as reagent stations, the reagents being present in corresponding vessels.

What is claimed is:

1. In a method for treating cytological or histological specimens in an automatic stainer or in a tissue processor, said specimens being delivered by means of a transport device to various processing stations, inserted there, and treated in accordance with a definable processing program, the improvement comprising the step of:
optimizing throughput on the basis of minimal movement distances of said transport device.

2. The improvement as defined in claim 1, wherein said movement distances of said transport device are minimized by means of a mathematical model.

3. The improvement as defined in claim 2, wherein said mathematical model comprises a graph theory approach.

4. The improvement as defined in claim 2, wherein said mathematical model comprises a network planning technique.

5. The improvement as defined in claim 1, wherein said movement distances of said transport device are minimized by arranging or rearranging the processing stations that are to be traveled to in a defined sequence in order to execute said processing program.

6. The improvement as defined in claim 1, wherein the transport device can move to other processing stations during the treatment of further specimens, so that concurrent processing, in different processing stations in accordance with multiple processing programs, is possible in throughput-optimized fashion.

7. The improvement as defined in claim 2, wherein said mathematical model is executed by a computer integrated into said automatic stainer or tissue processor.

8. The improvement as defined in claim 2, wherein said mathematical model is executed by an external computer.

9. The improvement as defined in claim 9, wherein said external computer is a personal computer.

10. The improvement as defined in claim 1, wherein said processing stations are reagent stations in an automatic stainer.
